(19) United States
(12) Patent Application Publication
(10) Pub. No.: US 2024/0118908 A1
(43) Pub. Date: Apr. 11, 2024

(54) METHODS AND APPARATUS FOR DATA ENCAPSULATION FOR OPERATING SYSTEMS

(71) Applicant: William E. Lamie, Rancho Santa Fe, CA (US)

(72) Inventor: William E. Lamie, Rancho Santa Fe, CA (US)

(21) Appl. No.: 18/377,651

(22) Filed: Oct. 6, 2023

Related U.S. Application Data
(60) Provisional application No. 63/414,434, filed on Oct. 7, 2022.

(51) Int. Cl. G06F 9/448

(52) U.S. Cl. CPC G06F 9/4488

(57) ABSTRACT

Methods and apparatus for enhanced encapsulation of global data or variables of an operation system program (e.g., a real-time operating system (RTOS) program). In one exemplary embodiment, apparatus may encapsulate a plurality of program global data into a single type-definition for subsequent instantiation of the single type-definition as a single global variable for use global data accesses. Unlike traditional techniques where each global variable is distinct and instantiated individually, the various aspects of the present disclosure are directed to improved global variable management, performance and corruption detection by, inter alia, guaranteeing placement of global variables in the same order they are defined. Moreover, various aspects of the present disclosure are directed to enhancements with respect to verification and technical support.

### PRIORITY AND RELATED APPLICATIONS

This application claims priority to co-owned and co-pending U.S. Provisional Patent Application Ser. No. 63/414,434, filed on Oct. 7, 2022 of the same title, which is incorporated herein by reference in its entirety.

Additionally, this application is generally related to the subject matter of co-owned and co-pending U.S. Provisional Patent Application Ser. No. 63/414,439, filed on Oct. 7, 2022, and entitled “METHODS AND APPARATUS FOR ENHANCED DATA CORRUPTION DETECTION,” incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### 1 Technological Field

The present disclosure relates generally to the field of computerized operating systems, including in one exemplary aspect computer programs and/or operating systems for, inter alia, deeply embedded and resource-constrained devices. Specifically, in one exemplary aspect, the present disclosure relates to global variables of a program (e.g., real-time operating system (RTOS) program and/or application program), how the global variables are defined and instantiated in a programming language (e.g., C programming language) and how the definition and instantiation thereof impacts the functionality of the program.

### 2. Description of Related Technology

Operating systems (OS) are well known in computerized systems. One species of such operating systems is the so-called Real-Time Operating Systems (RTOS). RTOS programs provide multithreading services to embedded applications running on memory and processing constrained devices. Many RTOS programs are written in the C programming language or variants thereof, although they are not limited to such language(s).

In order to provide multithreading services, RTOS programs necessarily require various global data for operation. This global data makes it possible for the RTOS to, inter alia, keep track of which thread is running, as well as which thread to execute next.

Additionally, some global data is associated with additional RTOS objects (e.g., queues, semaphores, mutexes, etc.). Traditionally, RTOS programs simply use standard C global variables for their global data needs. For example, suppose the RTOS keeps track of the currently executing thread with a global pointer, the pointer would simply be defined as a global C variable. The same is true for all the other global variables of the RTOS program.

### Exemplary RTOS Program Global Data Variable Definitions and Instantiations—

FIG. 1 shows an exemplary set of typical RTOS program global data variable definitions and instantiations in the C language (assuming the referenced types are already defined). Most RTOS programs have many more, and perhaps different, global variables; however, the small example shown in FIG. 1 is sufficient to illustrate deficiencies with existing RTOS implementations.

There are multiple shortcomings of the approach shown in FIG. 1.

Firstly, since each global variable is distinct and instantiated individually, the C compiler is required to generate a specific address before each access within a C function. This address generation requires additional instruction area memory, as well as additional processing cycles, both of which are prized resources in deeply embedded systems.

Furthermore, C compilers and their companion linkers that actually bind global variables to a physical address do not guarantee placement of the global variables in the same order they are defined—they can be located anywhere in the memory area designated for global variables (usually called the “.bss” section in most C implementations). This makes it virtually impossible to explicitly locate all RTOS program global data variables into high-speed memory, or lock the global variables into data cache for improved performance.

Moreover, having the RTOS program global variables scattered throughout memory may also contribute to or cause increased data cache “misses,” which translates to slower performance since the missed data must then be obtained from another cache or data source, which requires additional processing cycles.

Additionally, scattered global data is more difficult to detect corruption.

Finally, when customers using such RTOS programs contact technical support for help, it is difficult to gather the current value of all the RTOS global variables in various locations in memory.

Accordingly, improved apparatus and methods are needed to, inter alia, overcome the aforementioned deficiencies within such computer programs (e.g., an RTOS program and/or application programs). Such methods and apparatus would advantageously improve global variable management, performance and corruption detection by, inter alia, guaranteeing placement of global variables in the same order they are defined, thereby linking/locating all program global data variables into high-speed memory or locking the global variables into one or more data caches.

### SUMMARY

The present disclosure addresses the foregoing needs by providing, inter alia, apparatus and methods for enhanced program (e.g., OS, such as RTOS, and/or application program) encapsulation system.

In a first aspect of the disclosure, an improved method of encapsulation of variables (e.g., global variables) within a computerized operating system is disclosed. In one embodiment, the operating system comprises a Real-Time Operating Systems (RTOS), and the method includes encapsulating global data or variables into a single C typedef (type-definition), and then instantiating that single C typedef as a singular C global variable.

In one variant, the encapsulating of the plurality of program global data into the single type of data includes encapsulating all global variables of C-based source code program into a single C typedef. In one implementation, the encapsulating of all the data of the global variables into the single typedef includes encapsulating all the data of the global variable into a single global typedef accessible by all global RTOS operations.

In a further implementation, method includes prepending the data identifying the single global typedef to at least one global data access data structure (e.g., by referencing a global pointer “RTOS_Current_Thread,” thereby changing an access of a global “RTOS_Globals” to “RTOS_Globals.RTOS_Current_Thread”).

In one variant, the encapsulating and instantiating cooperate to cause use of respective memory locations having a prescribed relationship to one another, the prescribed relationship enabling performance of one or more functions which cannot be performed without the prescribed relationship.

In one implementation, the prescribed relationship includes the respective memory locations being disposed in a prescribed order or pattern. In another implementation, the one or more functions include at least one of an error detection or error correction function.

In another variant, the encapsulating of the plurality of program global data into the single type of data includes determining to encapsulate only a portion of a plurality of global variables of C-based source code program into a single C typedef, where the determining is based on one or more factors, the one or more factors comprising at least one of processing or memory limitations.

In yet another variant, the encapsulating of the plurality of program global data into the single type of data includes utilizing one or more machine learning algorithms to analyze data to determine to encapsulate the plurality of program global data.

In yet another variant, the method further includes: verifying the plurality of program global data; and based on the verifying of the plurality of program global data indicating the plurality of program global data is valid, causing at least one of (i) applying verification data to the single type of data, or (ii) updating existing verification data within the single type of data.

In one implementation, the verifying of the plurality of program global data includes: specifying plurality of program global data in respective storage locations according to at least one of a prescribed order or prescribed pattern; and utilizing knowledge of the at least one of the prescribed order or the prescribed pattern so as to facilitate performance of one or more other operations.

In another implementation, the causing of the at least one of (i) the applying of the verification data to the single type of data, or (ii) the updating of the existing verification data within the single type of data includes disposing one or more verification codes at a beginning of the plurality of program global data or at an end of the plurality of program global data, the one or more verification codes facilitating the detection of at least one of stack overflow or buffer overflow.

In a second aspect of the disclosure, a computerized embedded apparatus is disclosed. In one embodiment, the computerized embedded apparatus includes data storage apparatus; processor apparatus in data communication with the storage apparatus; and storage apparatus in data communication with the processor apparatus, the storage apparatus having at least one computer program having a plurality of instructions.

In one variant, the plurality of instructions are implemented to, when executed by the processor apparatus, cause the computerized apparatus to: execute an RTOS program; determine that access to particular global data is required by the RTOS program to perform a function of the RTOS; utilize data indicative of a single reference to aggregated global data to access the particular global data; and access the particular global data via the single reference to enable performance of the function.

In one implementation, the single reference to the aggregated global data includes a single reference to an encapsulation of the particular global data, the encapsulation utilizing less instruction memory area and instructions to execute than a code generation process that does not utilize the encapsulation.

In another implementation, the aggregated global data includes at least two sets of global data having a prescribed relationship.

In yet another implementation, the plurality of instructions are further implemented to, when executed by the processor apparatus, cause the computerized apparatus to: display the aggregated global data via a graphical user interface (GUI), wherein utilization of the data indicative of the single reference to the aggregated global data to access the particular global data enables the display to be effected with less individual accesses to different locations in memory than without the utilization of the data indicative of the single reference to the aggregated global data to access the particular global data, the display facilitating at least one of (i) troubleshooting, (ii) error correction, or (ii) debug, by a programmer or support entity.

In a third aspect of the disclosure, a computer readable apparatus is disclosed. In one embodiment, the computer readable apparatus includes a non-transitory storage medium having at least one computer program of a plurality of instructions.

In one variant, the plurality of instructions are implemented to, when executed by a processing apparatus, cause a computerized apparatus to: encapsulate global data used by a real-time operating system (RTOS) program into a single C typedef; and instantiate the single C typedef as a singular C global variable for subsequent use by the RTOS on an embedded target platform.

In one implementation, the plurality of instructions are further implemented to, when executed by the processing apparatus, cause the computerized apparatus to: determine to encapsulate the global data into the single C typedef based on one or more thresholds being met, the one or more thresholds comprising a number of bytes of the global data.

In another implementation, the plurality of instructions are further implemented to, when executed by the processing apparatus, cause the computerized apparatus to: apply a pragma extension to the instantiation of the single C typedef as the singular C global variable, the application of the pragma extension ensuring a minimal address alignment of bytes and an absolute address. The minimal address alignment of bytes and an absolute address can be utilized to lock the global data into at least one cache memory location associated with the computerized apparatus.

In a fourth aspect of the disclosure, an improved digital processor is disclosed. In one embodiment, the processor comprises an embedded device utilizing an RTOS having instructions configured to utilize one or more encapsulated global variables during application execution, such as for part of mutex, multi-thread, pointer, queue, or other operations.

In a fifth aspect of the disclosure, an improved method of register allocation is disclosed. In one exemplary embodiment, the method includes use of a single register reference for handling all (or prescribed subsets) of a global data variable population so as to simplify global data accesses, updates, etc.

In a sixth aspect of the disclosure, a non-transitory computer readable apparatus is disclosed. In one embodiment, the apparatus comprises a program memory of an embedded device, and includes logic (e.g., executable instructions) configured to allow an RTOS of the embedded device to utilize encapsulated global data.

In another embodiment, the apparatus comprises a program memory of a compiler or other process with logic configured to enable the compiler process to (i) identify a set of global variables to be encapsulated, and (ii) perform encapsulation of the identified global variables, so as to enable instantiation by the compiler of a single global variable, which can then be linked and used by a target platform to manage global data accesses via the single variable.

In one variant, the identification of the set of global variables includes identification of a plurality of global variables by a programmer. In another variant, the identification of the set of global variables includes identification of a plurality of global variables according to one or more rules. In one implementation, the global data/variables and/or other parameters (such as memory size) are analyzed via, e.g., machine learning and/or other heuristics, to determine the one or more rules.

In a seventh aspect of the disclosure, methods of error/corruption detection and verification are disclosed. In one embodiment, the methods include (i) specifying global data in respective storage locations according to a prescribed order and/or pattern, and (ii) utilizing knowledge of the prescribed order and/or pattern so as to facilitate performance of one or more other operations, such as cyclic redundancy checks, hashes, checksums, or even to increase performance of global data accesses by the RTOS during application execution (e.g., normal operations).

In one variant, one or more verification codes are utilized; and in some implementations, the verification codes are placed at the beginning and end of the data/variables. Such implementations are especially useful in detecting stack overflow and/or buffer overflow.

In an eighth aspect of the disclosure, methods of global data accumulation and presentation are disclosed. In one embodiment, the methods include utilizing the aforementioned order and/or pattern to enable rapid population of a user interface such as a GUI to facilitate troubleshooting, error correction, or debug by a programmer or support entity.

In a ninth aspect of the disclosure, an improved integrated circuit (IC) apparatus is disclosed. In one embodiment, the IC includes one or more processor cores, and comprises an embedded device utilizing an RTOS having instructions configured to utilize encapsulated global data during application execution, such as in support of mutex, multi-thread, pointer, queue, or other operations.

In a tenth aspect of the disclosure, an improved method for encapsulation of data and/or variables (e.g., global variables) in one or more computer programs is disclosed. In one or more embodiments, the one or more computer programs include at least one of (i) an operating system computer program, and/or (ii) an application program. In one variant, the operating system computer program comprises an RTOS program.

These and other aspects shall become apparent when considered in light of the disclosure provided herein.

### BRIEF DESCRIPTION OF THE DRAWINGS

FIG. 1 is a graphical representation of a set of prior art RTOS program global data variable definitions and instantiations in the C language.

FIG. 2 is a logical flow diagram of one exemplary method for providing enhanced encapsulation of global data, in accordance with various aspects of the present disclosure.

FIG. 2A is a logical flow diagram of one exemplary implementation for providing enhanced encapsulation of global data, in accordance with various aspects of the present disclosure.

FIG. 3 is a graphical representation of one exemplary enhanced encapsulation code structure, in accordance with various aspects of the present disclosure.

FIGS. 4A and 4B are graphical representations showing a comparison of exemplary C code generation for the ARM Cortex-M3 processor of the encapsulated RTOS program global data, in accordance with various aspects of the present disclosure, vs. exemplary C code generation of RTOS program global data in accordance with existing techniques, respectively.

FIG. 5 is a logical flow diagram of one exemplary method for providing enhanced encapsulation of global data to, inter alia, facilitate verification of the global data, in accordance with various aspects of the present disclosure.

FIG. 6 is a graphical representation of one exemplary embodiment of an encapsulation code structure for RTOS global data to, inter alia, facilitate easier verification and corruption detection of the RTOS global data, in accordance with various aspects of the present disclosure, and more specifically, with the exemplary methodology of FIG. 5.

FIG. 7 is a logical flow diagram of one exemplary method for providing enhanced encapsulation of global data to, inter alia, facilitate the linking or locating of the global data to a specific memory address and with a specific memory alignment, in accordance with various aspects of the present disclosure.

FIG. 8 is a graphical representation of one exemplary embodiment of an encapsulation code structure for RTOS global data to, inter alia, facilitate its alignment and physical location through commonly available C compiler pragma support, in accordance with various aspects of the present disclosure, and more specifically, with the exemplary methodology of FIG. 7.

FIG. 9 is a logical flow diagram of one exemplary method for providing enhanced encapsulation of global data to, inter alia, facilitate easier viewing and sharing of the global data, such as e.g., in a technical support context, in accordance with various aspects of the present disclosure.

FIG. 10 is a graphical representation of one exemplary embodiment of an encapsulation data structure for RTOS global data to, inter alia, facilitate easier viewing of RTOS program global data and communicating the RTOS global data during RTOS technical support, in accordance with various aspects of the present disclosure, and more specifically, with the exemplary methodology of FIG. 9.

FIG. 11 is a graphical representation of one exemplary embodiment of a typical memory layout incorporating the enhanced encapsulated global variable data, in accordance with various aspects of the present disclosure.

FIG. 12 is a logical block diagram of an enhanced program (e.g., RTOS and/or application program) encapsulation and compiling system, useful to illustrate various aspects of the present disclosure.

FIG. 13 is a logical block diagram of an enhanced encapsulation processing apparatus, useful to illustrate various aspects of the present disclosure.

FIG. 14 is a logical block diagram of an enhanced processing or computing apparatus, useful to illustrate various aspects of the present disclosure.

### DETAILED DESCRIPTION

Reference is now made to the drawings wherein like numerals refer to like parts throughout.

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and an application may have more than one theme. The unit of executable software generally runs in a predetermined environment. For example, a processor apparatus may obtain and execute instructions from a non-transitory computer-readable storage medium where the instructions are compiled for the processor.

As used herein, the term “computer program” or “software” is meant to include any sequence or human or machine cognizable steps which perform a function. Such program may be rendered in virtually any programming language or environment including, for example and without limitation, C/C++, Fortran, Java™ (including J2ME, Java Beans, etc.), Register Transfer Language (RTL), VHSIC (Very High Speed Integrated Circuit) Hardware Description Language (VHDL), Verilog, and the like. Such computer programs or software can be divided into pieces, commonly called “tasks” or “threads,” and each thread may retain its own copy of the contents of executed resources as if they were the thread's own private resources (i.e., a thread's “context”).

As used herein the terms “C” and “C programming language” refer without limitation to ANSI C, C#, C++, and/or Objective-C, as well as other “C family” languages such as for example Python, Java, JavaScript, Perl, PHP, Verilog, D, Limbo and C shell of Unix.

As used herein, the term “memory” includes any type of integrated circuit or other storage device adapted for storing digital data including, without limitation, read-only memory (ROM), programmable ROM (PROM), electrically erasable PROM (EEPROM or E2PROM), random access memory (RAM), dynamic RAM (DRAM), synchronous dynamic RAM (SDRAM) including double data rate (DDR) class memory and graphics DDR (GDDR) and variants thereof (e.g., DDR/2 SDRAM), ferroelectric RAM (FeRAM), magnetic RAM (MRAM), resistive RAM (RRAM), reduced-latency DRAM (RLDRAM), static RAM (SRAM), magnetoresistive RAM (MRAM), such as spin torque transfer RAM (STT RAM), “flash” memory (e.g., NAND/NOR), 3D memory, and pseudostatic RAM (PSRAM). Extended Data Out Fast Page Mode (EDO/FPM) memory, phase change memory (PCM), and 3-dimensional cross-point memory (3D Xpoint).

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), programmable logic devices (PLDs), reconfigurable computer fabrics (RCFs), array processors, secure microprocessors (i.e., physically secure micros), and application-specific integrated circuits (ASICs). Such digital processors may be contained on a single unitary IC die, or distributed across multiple components.

As used herein, the term “interface” refers to any signal or data interface with a component or network, whether, wireline, optical, or wireless, including without limitation those of the Thunderbolt, FireWire (e.g., FW400, FW800, etc.), USB (e.g., USB 2.0, 3.0., 3.1, 3.2, 4, OTG), Ethernet (e.g., 10/100, 10/100/1000 (Gigabit Ethernet), 10-Gig-E, etc.), Wi-Fi (IEEE Std. 802.11 WLAN), cellular data (e.g., 5G NR, LTE, 3G), Bluetooth/PAN, IEEE Std. 802.15, ZigBee, LoRAWAN, Infrared (IR), or other.

As used herein, the term “Real-Time Operating System” or “RTOS” refers without limitation to system software that provides multithreading services to embedded applications running on memory and processing constrained devices. More specifically, RTOSes allocate processing time among various duties that the embedded software must perform, typically by dividing the software into portions, commonly called “tasks” or “threads,” and creating a run-time environment that provides each thread or task with its own virtual microprocessor (i.e., “multithreading”). Examples of the RTOS may include, without limitation, Azure RTOS ThreadX™ provided by Microsoft®, Nucleus RTOS™ provided by Siemens®, Versatile Real-Time Executive (VRTX) provided by Mentor Graphics®, Operating System Embedded (OSE)™ provided by Enea®, FreeRTOS, REX OS provided by Qualcomm®, OKL4 provided by Open Kernel (OK) Labs®, or any other suitable RTOS.

As used herein, the term “resource” refers in one context to a hardware or software unit that is provided by a computing device, including, without limitation, processor cycles, processor time, memory including memory capacity, peripherals, interrupts, network bandwidth, video frame buffers, and sound cards.

As used herein, the term “virtual microprocessor” is meant generally to include any type of processing of a virtual set of microprocessor resources including, without limitation, a register set, program counter, stack memory area, and a stack pointer.

### Overview

As discussed elsewhere herein, most RTOS programs have many different global variables. Typically, each global variable is distinct and instantiated individually. Such individual instantiation of each distinct global variable requires significant amounts of memory and may consume numerous processing cycles.

Additionally, with existing techniques, C compilers and their companion linkers that bind global variables to a physical address do not guarantee placement of the global variables in the same order they are defined, resulting in global variables being scattered throughout memory. The scattering of global variables causes increased data cache misses, which translates to slower performance. Yet additionally, it is more difficult to detect corruption with scattered global data. Yet additionally, when customers using such RTOS programs contact technical support for help, it is difficult to gather the current value or state of all the RTOS global variables in various locations in memory.

To these ends, techniques for providing enhanced encapsulation of the program (e.g., RTOS program and/or application program) capable of, inter alia, guaranteeing placement of global variables in the same order they are defined, are desired and disclosed herein.

Specifically, the present disclosure describes, inter alia, techniques and apparatus for enhanced encapsulation of OS variables (including Real-Time Operating Systems (RTOS) program global variables) within a single type definition, which alleviates the aforementioned deficiencies. The techniques and apparatus for enhanced encapsulation of the present disclosure can also apply to application code/programs.

In one particular implementation of the present disclosure, the RTOS program C global data is encapsulated into a single C typedef (type-definition), and then that C typedef is instantiated as a singular C global variable. This advantageously produces smaller and faster code, and makes it possible to locate the global data in higher-speed memory or lock the global data into data cache.

Additional features include, among others, enhancements which make it easier to detect corruption of RTOS program global memory, and which help RTOS users efficiently provide the current status of all RTOS program global memory, such as in a technical support context.

Advantageously, the disclosed methods of encapsulation of global data and associated apparatus can be applied to all languages which utilize such global data, including to all C-based or C-family programs which routinely utilize extensive global C data, such as e.g., file systems, network stacks, and other similar applications.

### Detailed Description of Exemplary Embodiments

Exemplary embodiments of the apparatus and methods of the present disclosure are now described in detail. While these exemplary embodiments are described in the context of the C program language, other types of programming languages—including, without limitation, Java™ Register Transfer Language (RTL), VHSIC (Very High Speed Integrated Circuit) Hardware Description Language (VHDL), Verilog, and the like—may be used consistent with the present disclosure.

It will also be appreciated that while described generally in the context of operating systems (e.g., RTOS), the present disclosure may be readily adapted to other types of data, such as that of application code/programs.

Other features and advantages of the present disclosure will immediately be recognized by persons of ordinary skill in the art with reference to the attached drawings and detailed description of exemplary embodiments as given below.

### Exemplary Methods

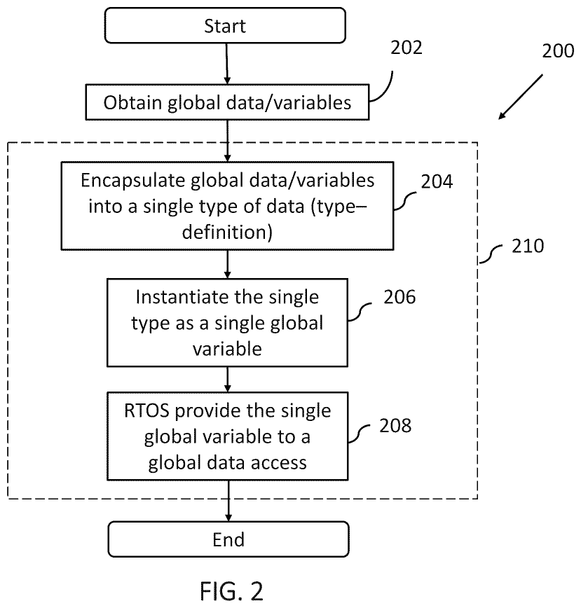

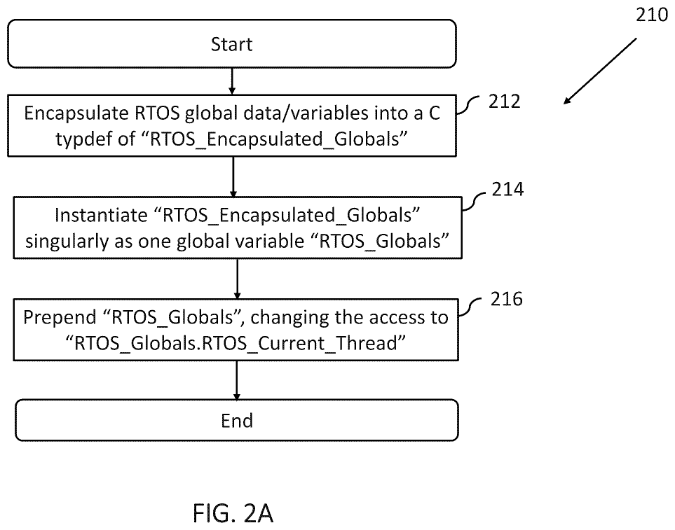

Referring now to FIG. 2, one embodiment of a general methodology 200 for providing enhanced encapsulation of global data is described.

As shown, per step 202, global data is obtained. In one variant, the obtaining of the global data comprises reading global variables of a program (e.g., RTOS and/or application program), such as from the data segment (.bss) of the RTOS program memory described elsewhere herein.

At step 204, the global data/variables is/are encapsulated as a single type of data (e.g., a single C typedef (type-definition)). In one variant, the global data is encapsulated as the single typedef “RTOS_Encapsulated_Globals” (see step 212 of FIG. 2A).

Several implementations of this encapsulation process are possible. For example, in some implementations, a programmer can create a typedef for the global data and decide which global data to encapsulate using the typedef (e.g., all global data or a portion of the global data, for example based on processing limitations).

In other implementations, the encapsulation process is at least substantially computer-based. For example, computerized logic (such as machine code having a plurality of machine language instructions) and/or a compiler could gather global data together and utilize the typedef for encapsulation based on one or more rules. More specifically, in some implementations, for every global variable, the compiler first generates an absolute address to read/write that global variable; and for variables that are larger than a word, the compiler generates register-relative addressing to read/write memory after the initial word. Additionally, encapsulation can occur based on one or more triggers, such as when global variables reach a certain amount of words, or consume a prescribed amount of data in memory. A programmer or application developer can define these rules/triggers, and/or machine learning and/or other heuristics can analyze data (e.g., the global data/variables, the type/size of the memory, etc.) to determine the rules/triggers.

At step 206, the single type is instantiated as a single global variable.

At step 208, the instantiated global variable is supplied in front of any global data access.

Referring now to FIG. 2A, one exemplary implementation of the method 210 for providing enhanced encapsulation of global data in accordance with the present disclosure is described.

As shown, per step 212 of the method 210, the desired global data is encapsulated into the C typedef “RTOS_Encapsulated_Globals.” It will be appreciated that while the exemplary implementations described herein encapsulate all global data, this encapsulation may be modified or parsed as desired. For instance, portions of the global data (e.g., such as those portions which bear some sort of logical or other relationship to one another, or which have some common utility or functionality), may be encapsulated together as sets, with multiple (e.g., two or more) sets being used together, as opposed to one “global” encapsulation of all global data. While this produces somewhat of a reduction of the code efficiency previously described, it may have other benefits which outweigh the reduction of efficiency and hence may be useful in some applications. For example, it may be advantageous to split the data for multiple encapsulations if the code becomes too big, e.g., to perform register relative addressing, due to limitations on processors (e.g., ARM Cortex-M processor) regarding the number of bytes.

At step 214, the C typedef “RTOS_Encapsulated_Globals” is instantiated as one C global “RTOS_Globals.”

Specifically, unlike the existing techniques which performs separate global variable instantiation of the RTOS program global data (i.e., on a per-data basis), the exemplary methodology of the present disclosure provide encapsulation of all of the into the C typedef “RTOS_Encapsulated_Globals” and then instantiated as one C global “RTOS_Globals.”

At step 216, the RTOS program supplies the instantiated name “RTOS_Globals” in front of any global data access. For example, the traditional RTOS program access to the currently running thread pointer would simply amount to referencing the sample global pointer “RTOS_Current_Thread.” Using the encapsulation technique, the RTOS program code would instead prepend “RTOS_Globals”, changing the access to “RTOS_Globals.RTOS_Current_Thread.”

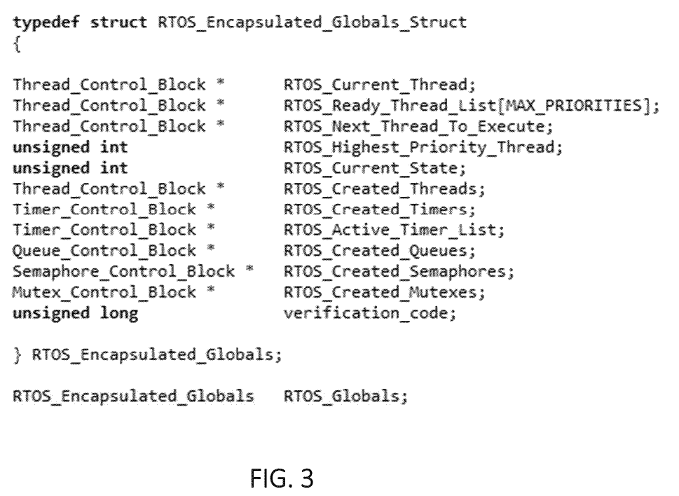

FIG. 3 is a graphical representation of one exemplary enhanced encapsulation into a C typedef (and instantiation into a single C global variable), in accordance with the exemplary methodologies of FIGS. 2 and 2A, described supra.

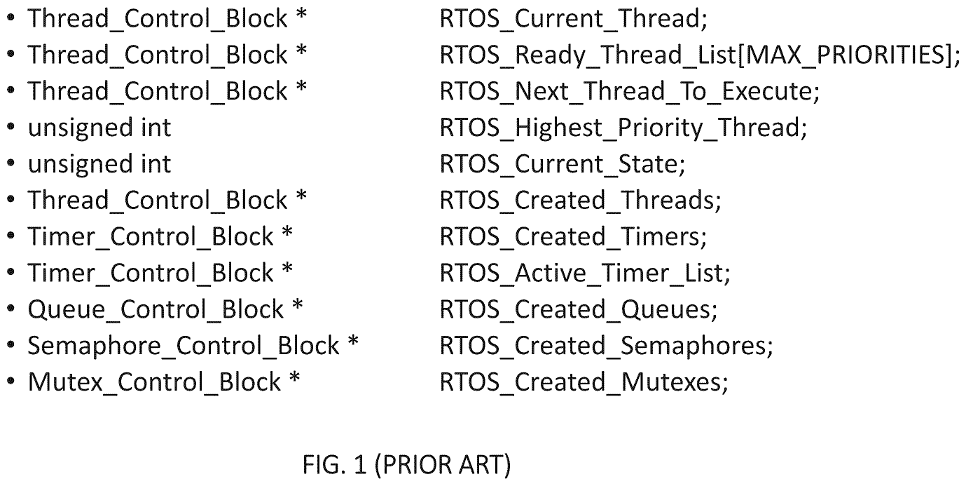

More specifically, FIG. 3 shows one exemplary embodiment for encapsulation of RTOS program global data into a single C typedef and then instantiating this type as a singular C global variable. The sample RTOS program global data is the same as what was described elsewhere herein for FIG. 1, but instead of separate global variable instantiation, all of the data in FIG. 3 is encapsulated into the C typedef “RTOS_Encapsulated_Globals” and then instantiated as one C global “RTOS_Globals.” In addition to encapsulating the C global data into a typedef, the RTOS program also supplies the instantiated name “RTOS_Globals” in front of any global data access. For example, the traditional RTOS program access to the currently running thread pointer would simply amount to referencing the sample global pointer “RTOS_Current_Thread.” Using the encapsulation technique, the RTOS program code would instead prepend “RTOS_Globals”, changing the access to “RTOS_Globals.RTOS_Current_Thread.”

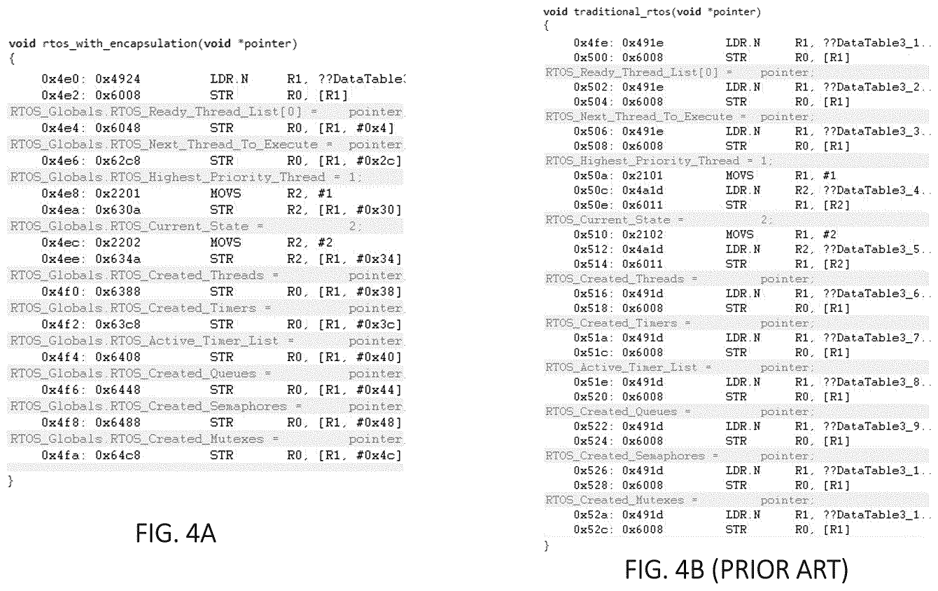

FIGS. 4A and 4B illustrate a comparison of C code generation for the ARM Cortex-M3 processor of the encapsulated RTOS program global data, according to one exemplary embodiment of the present disclosure, vs. the traditional RTOS global data instantiation, respectively. Specifically, one exemplary embodiment of encapsulation is used as a basis for comparison (the impact on program size and performance of FIG. 4A is shown in comparison with the traditional, non-encapsulated approach of FIG. 4B for the exemplary Cortex processor).

The exemplary encapsulated code of FIG. 4A shows that the compiler builds one 32-bit address for the RTOS global data area, and stores it in register R1 (at instruction address 0x4e0). From this point, all RTOS global data references are R1-relative, meaning there is no more code generation associated with building the addresses of the various RTOS global data variables. In contrast, the code generation for the traditional RTOS (FIG. 4B) shows that for each and every RTOS global variable access, the compiler generates code to build the address and store in R1/R2 (at instruction addresses 0x4fe, 0x502, 0x506, 0x50c, 0x512, 0x516, 0x51a, 0x51e, 0x522, 0x526, and 0x52a). It will be appreciated that this effect is magnified as more variables are used/added; a longer list of variables necessitates more individual codes/addresses being generated, along with the attendant processing overhead and latency. Hence, the benefits of the encapsulation approach described herein multiply as the list of global variables gets longer.

To illustrate this point, the traditional RTOS code in the example of FIG. 4B requires 24 assembly instructions, while the RTOS program with encapsulated global in the example of FIG. 4A requires only 14 instructions—to implement exactly the same functionality. This is roughly a 41% improvement in both instruction memory area and number of instructions to execute (performance).

It will further be appreciated that some degree of electrical power savings may be realized using the aforementioned encapsulation approach; this can be particularly significant for small/low power embedded devices which may have limited power availability or battery capacity, such as e.g., distributed IoT (Internet of Things) sensors or similar devices. Less code, and less code execution, translate to reduced power consumption for the same set of executed instructions (including fewer cache “misses” as discussed elsewhere herein), as well as less memory storage requirements (since the global variable data is not “scattered” throughout memory, and hence can be more efficiently packed).

### Verification—

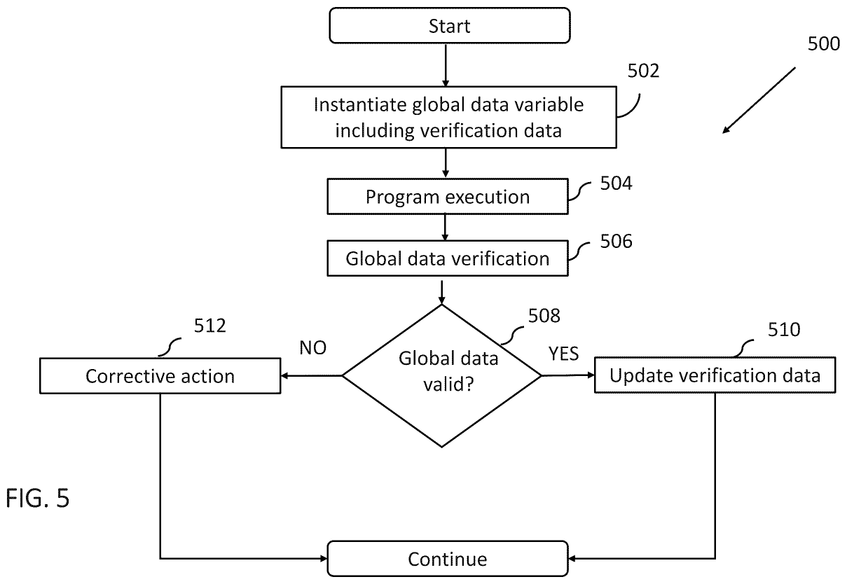

Referring now to FIG. 5, one embodiment of a general methodology 500 for providing enhanced encapsulation of global data to, inter alia, facilitate verification of the global data is described.

As shown, per step 502, the desired global data/variables are obtained, encapsulated and instantiated. In some exemplary embodiments, step 502 is performed in accordance with at least one of FIG. 2 or 2A, described supra. The desired data may include all or a subset of the global data referenced supra.

At step 504, the generated executable(s) having the encapsulated variables/data reflected therein is/are executed on the target platform (e.g., ARM Cortex) via the RTOS.

At step 506, verification of the global data is performed. In some embodiments, the verification can be of any type such as e.g., those known in the art, including without limitation, a checksum, CRC, hash, or other calculation over the RTOS global data. As described elsewhere herein, since the placement of the global data within the available memory space is not “scattered” as in the prior art un-encapsulated approaches, such verification calculations are facilitated and readily performed, since the locations of the variable data are known and readily determined (including e.g., being placed in contiguous or semi-contiguous fashion or other order, the placement which can also be selected to facilitate such calculations, such as to enable more efficient radix or other types of mathematical operations).

If the verification indicates that the global data is valid (step 508) then per step 510, the verification data is stored as a code (e.g., “verification_code”) within the encapsulated global data (or existing data is updated).

Additionally, various embodiments of the present disclosure may utilize the verification techniques described in co-owned and co-pending U.S. Provisional Patent Application Ser. No. 63/414,439, filed on Oct. 7, 2022, and entitled “METHODS AND APPARATUS FOR ENHANCED DATA CORRUPTION DETECTION,” incorporated supra. For example, in one exemplary embodiment, verification code markers (e.g., “verification_code”) can be placed at the beginning and end of the typedef. These markers have a data pattern, and some type of memory corruption can be inferred if that data pattern on either of the markers was incorrect. Even though such technique may not be as strong as using CRC or checksum, it would still effective and have less overhead. Such technique of placing the verification code markers/values is especially useful in certain contexts, such as in detecting stack overflow and/or buffer overflow.

Referring back to steps 508 and 510 of FIG. 5, in one variant, the verification code can be checked by the RTOS (or application code via an exposed application programming interface (API)) to detect any unauthorized or undesired changes to the RTOS program global data. In another variant, upon each authorization of RTOS program global data, the verification code would be updated accordingly.

Alternatively, if the verification indicates that the global data is not valid (per step 508), then, per step 512, the verification code is not stored, and corrective or remedial action is taken to identify the source of the corruption/error. For example, in one variant, a system error handler would be called, such as the system error handler as described in co-owned and co-pending U.S. Provisional Patent Application Ser. No. 63/414,439, filed on Oct. 7, 2022, and entitled “METHODS AND APPARATUS FOR ENHANCED DATA CORRUPTION DETECTION,” incorporated supra, which alerts the system that there is a fatal error. The application may override the default processing which would basically be a reset.

At step 512, the encapsulated single type def with the verification data (or updated verification data) is instantiated as a single global variable.

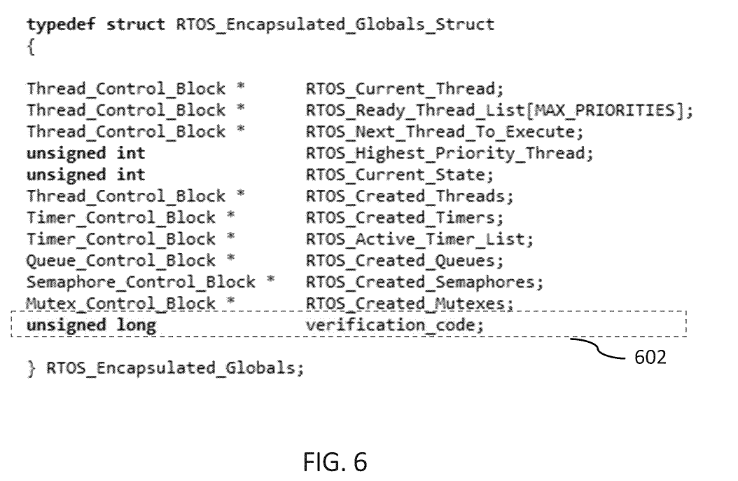

FIG. 6 illustrates one exemplary embodiment of an encapsulation code structure for RTOS global data, which helps facilitate easier verification and corruption detection of the RTOS global data, in accordance with the present disclosure, and more specifically, with the exemplary methodology of FIG. 5 described supra.

As shown in FIG. 6, a “verification_code” member 602 is introduced to the RTOS program global data typedef.

Given that, by virtue of the encapsulation process, all the RTOS program global data is now contiguous (or at least in a prescribed placement/order), it is possible (and in fact relatively straightforward) to perform a checksum, CRC, hash, or other calculation over the RTOS global data and store the resulting data (or portions thereof) in “verification_code” 602. This can then be checked by the RTOS (or other means, such as application code via an exposed API) to detect any unauthorized or undesired changes to the RTOS program global data.

As explained elsewhere herein, in some variants of the exemplary embodiment of FIG. 6, the verification code 602 used can be that which is described in co-owned and co-pending U.S. Provisional Patent Application Ser. No. 63/414,439, filed on Oct. 7, 2022, and entitled “METHODS AND APPARATUS FOR ENHANCED DATA CORRUPTION DETECTION,” incorporated supra.

### Pragma Support—

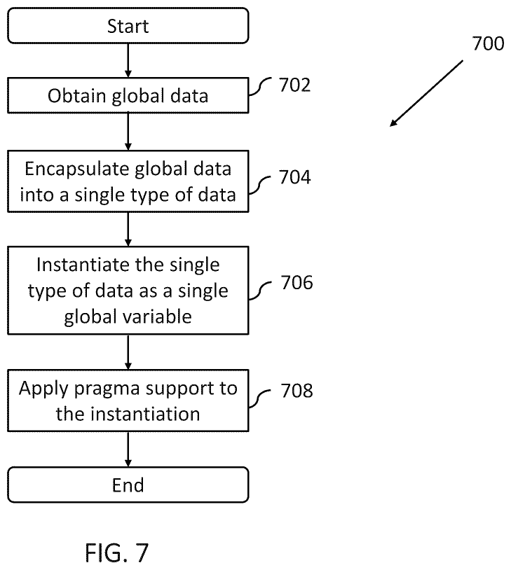

Referring now to FIG. 7, one embodiment of a general methodology for providing enhanced encapsulation of global data for, inter alia, facilitating the linking or locating of the global data to a specific memory address and with a specific memory alignment is described.

As shown, per step 702 of the method 700, global data is obtained.

At step 704, the global data is encapsulated as a single type of data (e.g., a single C typedef).

At step 706, the single type of data is instantiated as a single global variable.

In various embodiments, steps 702, 704, and 706 are performed in accordance with at least one of FIG. 2 or 2A, described supra.

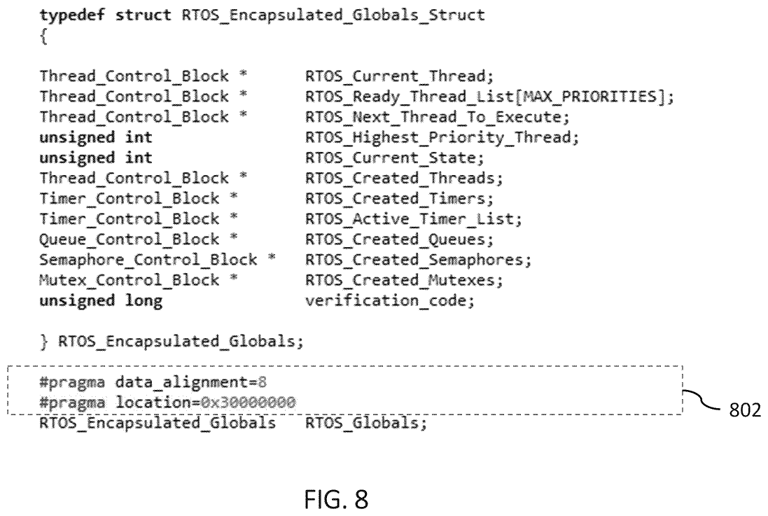

At step 708, a pragma extension (e.g., a common embedded C pragma extension) is applied to the instantiation. The application of the pragma extension advantageously ensures a minimal address alignment of bytes (e.g., 8-bytes) and an absolute address (e.g., of 0x30000000) as shown in greater detail with respect to FIG. 8. The alignment and address are in this implementation arbitrary but illustrate the ease in which the encapsulation of RTOS global data can be managed in memory.

It will also be appreciated that the collection of the RTOS program global data, alignment and address control can be used to lock the global data into cache (e.g., one or more cache memory locations associated with the host embedded or other processor), and reduce cache misses that might result from the traditional “scattered” global data approach of traditional RTOS programs. FIG. 8 illustrates one exemplary encapsulation of the RTOS global data, which facilitates its alignment and physical location through commonly available C compiler pragma support, according to one embodiment of the present disclosure, consistent with the exemplary methodology of FIG. 7 described supra.

Specifically, FIG. 8 illustrates encapsulation of the RTOS program global data into the “RTOS_Encapsulated_Globals” typedef, which facilitates the linking/locating of the RTOS program global data to a specific memory address and with a specific memory alignment via the illustrated pragma 802. In this implementation, a common embedded C pragma extension 802 is used that is easily applied to the instantiation, which in this example ensures a minimal address alignment of 8-bytes and an absolute address of 0x30000000.

### Technical Support—

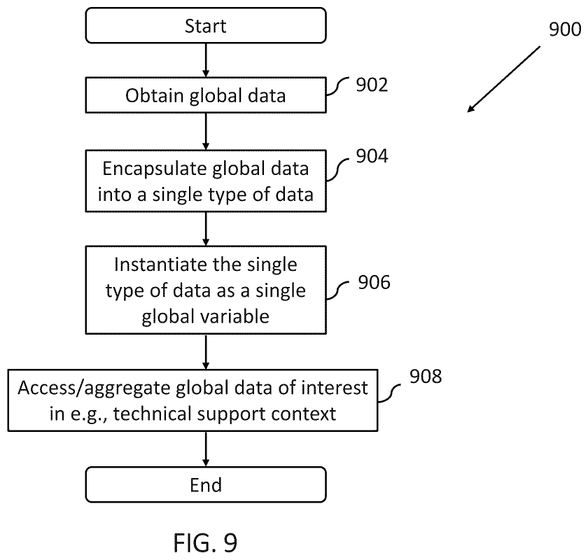

Referring now to FIG. 9, one embodiment of a general methodology for providing enhanced encapsulation of global data to, inter alia, facilitates easier viewing and sharing of the global data, such as e.g., in a technical support context, is described.

As shown, per step 902 of the method 900, global data is obtained.

At step 904, the global data is encapsulated as a single type of data (e.g., a single C typedef).

At step 906, the single type of data is instantiated as a single global variable.

In various embodiments, steps 902, 904, and 906 are performed in accordance with at least one of FIG. 2 or 2A, described supra.

At step 908, the encapsulated global data is aggregated (and optionally displayed) for provision during technical support functions. In one variant, a graphical user interface (GUI) is provided to facilitate viewing for the application developer using the RTOS. The enhanced encapsulation according to the various aspects of the present disclosure makes it easier to share all the RTOS program global data in a technical support context. Without such encapsulation, developers are required to gather the information from various locations in memory, which can be a laborious process. With encapsulation of the program data/variables, this can be accomplished instantly via, e.g., a C data watch in most debug environments.

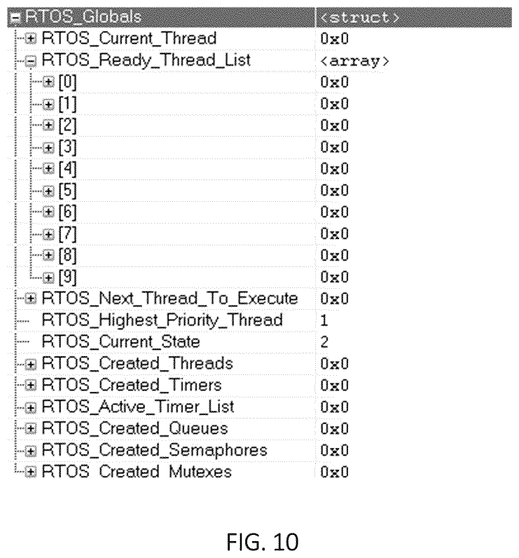

FIG. 10 illustrates encapsulating RTOS global data helps facilitate easier viewing of RTOS program global data and communicating the RTOS global data during RTOS technical support, consistent with the exemplary methodology of FIG. 9 described supra.

Notably, without encapsulation, developers are required to gather the information from various locations in memory, which can be a laborious process, and is exacerbated by a high number of variables (i.e., more variables means more individual accesses to different and potentially “scattered” locations in memory). With encapsulation of the RTOS program global data, this aggregation of the data relating to the different variables can be accomplished instantly, such as via a C data watch present in most debug environments.

### Exemplary Memory—

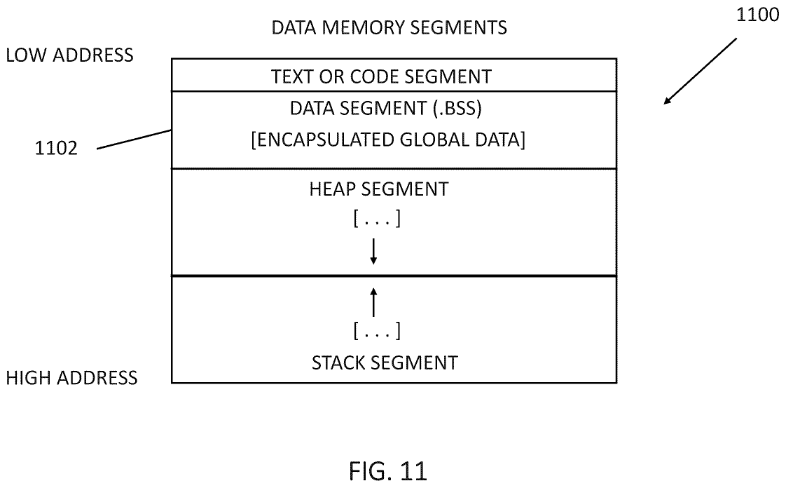

Referring now to FIG. 11, one exemplary embodiment of a typical memory layout incorporating the enhanced encapsulated global variable data is shown and described in detail.

As shown, the memory layout 1100 includes a plurality of memory segments: the text or code segment, the data segment 1102, a stack segment, and a heap segment. The text or code segment includes the executable part of the program with the assembly instructions. The data (.bss) segment 1102 holds the variables or pointers to variables used in the application. In one exemplary embodiment of the present disclosure, the data (.bss) segment is where the encapsulated global data variables are stored, although this is not in any way limiting; other regions (such as an initialized data segment of the memory (not shown) may be used to store part or all of the encapsulated global variables.

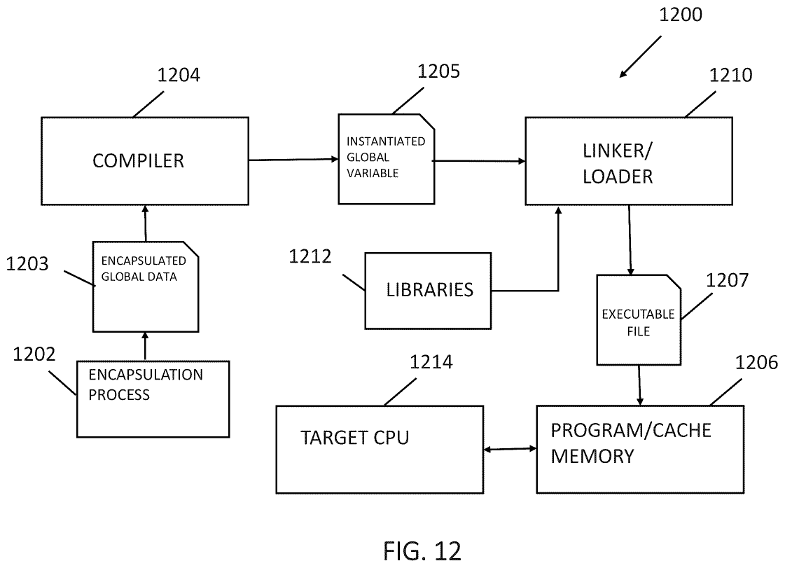

In one variant of the present disclosure, the global variables encapsulated as a single typedef are read from, e.g., the “.bss” segment. The single typedef is instantiated by a compiler (see FIG. 12) as a single global variable, and supplied to program access.

The stack and heap segments are used by the application to store and operate on temporary data (variables) that are used during the execution of the program. Specifically, the heap segment is used to support dynamic memory allocation. The stack segment is used to store variables which are created inside functions (main function or user-defined function). The variables stored in the stack segment include local variables of the function (including pointer variables), arguments passed to function, and return addresses.

### Exemplary System and Components—

Referring now to FIG. 12, one exemplary embodiment of an enhanced RTOS program encapsulation and compiling system 1200 is shown and described in detail.

As illustrated, the system 1200 includes a compiler process 1204 (which may run for example on a central processing unit (CPU) or other platform) configured to, inter alia, compile the C-based source code program into an intermediate code representation such as assembly language, prepare data, and other typical compiler functions. As described previously herein, an enhanced encapsulation function or process 1202 encapsulates global data variables of an RTOS program and/or data of an application code into a single type of data, and the compiler instantiates that single type of data as a single global variable 1205, thereby reducing code complexity and required operations by the compiler (and downstream processes such as the linker 1210, and ultimately the target platform 1214 running the generated executable (object) code).

In one variant, the instantiated single global variable data 1205 is ultimately stored into the memory space to be accessed as part of execution of the program at runtime, such as for multithreading operation control by the RTOS of the target processor, control of queues, semaphores, mutexes, etc. More specifically, in the exemplary embodiments of the present disclosure, the single global variable is accessed using e.g., two memory instructions executed by the processor core: (i) one instruction to load the address of the variable, and (ii) a second instruction to read/write the variable.

As illustrated, the system 1200 includes an encapsulation process 1202 which, in one exemplary embodiment, is configured to encapsulate the selected global data variables into a single typedef (see, e.g., the example of FIG. 3 herein wherein thread control, mutex, semaphore, queue, and timer global data variables are encapsulated as the single “RTOS Globals” typedef), which allows subsequent instantiation of the single typedef as a single global variable, and subsequent use of the single global variable as part of global data accesses by the RTOS.

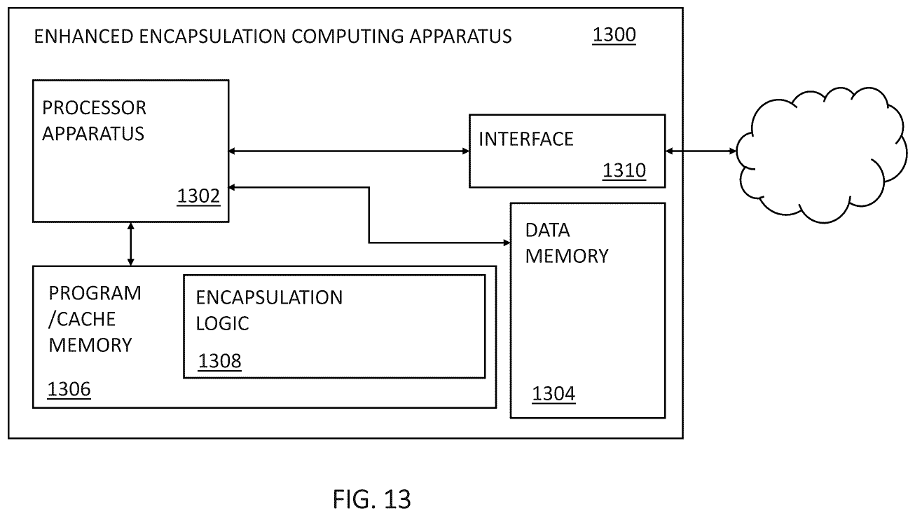

In one variant, the compiler “preprocessing” stage (not shown) is configured to include the encapsulation process 1202, although other approaches (including the illustrated separate encapsulation process/apparatus, such as in FIGS. 12 and 13) may be used with equal success.

According to some embodiments of the present disclosure, the encapsulation process 1202 may rely on programmer input to select variables for inclusion in the single typedef. However, in some embodiments, the encapsulation process 1202 may rely machine code, such as position-independent code (PIC), which can be utilized for addressing (relative address in the context of PIC) in order to read/write the variables from memory and know which variables to include (e.g., all variables, or just a portion of the variables based on one or more rules, such as exceeding a prescribed number of bytes).

Other functions of the pre-processing function(s) can include, without limitation, removal of comments, translation, and any other pre-processing function known in the art in order to present a single file to the compiler 1204.

The compiler 1204 creates output code (e.g., assembly code) from the file received from the enhanced encapsulation apparatus 1202 as well as the C source code and stores it. In one variant, the compiler 1204 selectively invokes the enhanced encapsulation apparatus/process 1202 based on user program inputs (e.g., selection of a user-specified variable or flag).

The resulting code generated by the compiler 1204 is incomplete, as it is missing actual memory addresses of functions and data variables defined elsewhere.

The linker/loader 1210 then utilizes the output from the compiler, along with libraries 1212, to create an executable file 1207 (object code), which is ultimately stored in program or cache memory 1206 of the target platform 1214 (e.g., an embedded device or processor).

The linker apparatus 1210 may in some embodiments calculate the size of global data areas for the system application (based on e.g., user selections of all or portions of the global data variable set), and reference specific locations based on calculated offsets for the memory.

As previously noted, extant C compilers and linkers do not guarantee placement of the global variables in the same order they are defined—they can be located anywhere in the memory area designated for global variables (usually the “.bss” section of FIG. 11 in many C implementations). This makes it virtually impossible to explicitly locate all RTOS program global data variables into high-speed memory or lock the global variables into data cache for improved performance. By use of the enhance encapsulation function 1202 of the present disclosure, the compiler only has to “build” e.g., one address for the RTOS global data area and store it in a register (e.g., R1) at an instruction address. From that point, all RTOS global data references are relative to that specific register, meaning there is no more code generation associated with building the address of RTOS global data variables. This not only reduces that amount of required assembly instructions, thereby improving both instruction memory area and the number of instructions to execute (performance), but also facilitates easier alignment and address control.

FIG. 13 illustrates one exemplary embodiment of an enhanced encapsulation processing apparatus 1300 useful with the present disclosure. As shown, program memory 1306 includes a plurality of executable CPU instructions, which includes executable instructions or logic 1308 (previously described) to encapsulate global data as a single type of data and instantiate the encapsulated global data as a single global variable.

In one or more variants, the executable instructions or logic 1308 identifies and collects global data based on one or more rules/triggers. For example, the one or more rules can indicate that an absolute address is to be generated to read/write each global variable to/from memory, and for variables that are larger than a word, register-relative addressing is generated to read/write memory after the initial word. As another example, the executable instructions or logic 1308 determines whether the global data/variables meet or exceed a prescribed threshold of data/words in order utilize addressing (e.g., register relative addressing) to gather and encapsulate the global data/variables into a typedef. Machine learning and/or other heuristics, in some implementations, can be utilized to analyze various data to determine such rules/triggers; and in other implementations, such rules/triggers can be set by a programmer/developer.

The enhanced encapsulation apparatus 1300 also includes the processor apparatus 1302, data memory 1304, and a network interface 1310 for communication with e.g., another device running the compiler 1204 of FIG. 12 when the two processes/functions are not co-located or integrated.

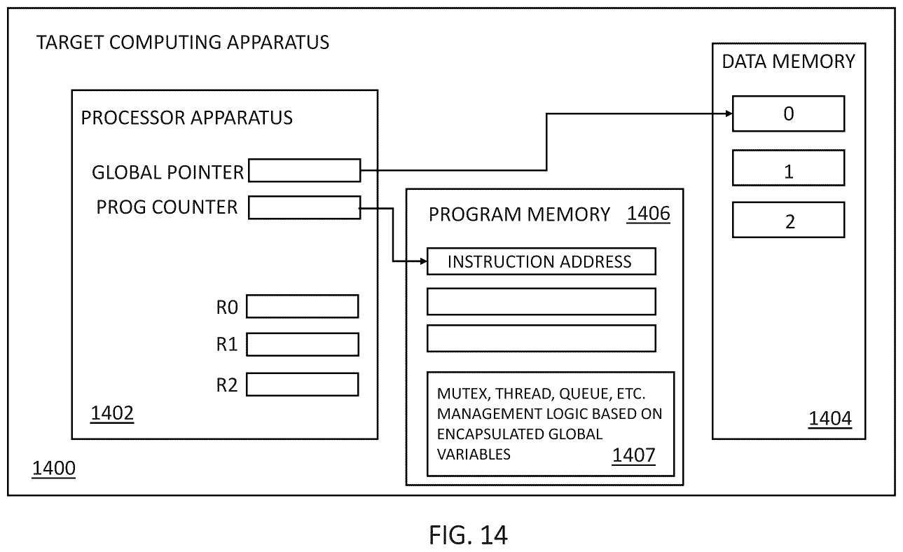

FIG. 14 illustrates an exemplary embodiment of an enhanced processing or computing apparatus 1400 configured according to the present disclosure. As shown, the enhanced computing apparatus 1400 generally comprises a processor core (or cores) 1402, a program memory apparatus 1406 (e.g., flash or other non-volatile memory), data memory 1404 (e.g., RAM/ROM), and one or more wireless or wireline data interfaces (not shown) for interfacing with, inter alia, external networking devices or other components, as well as in some embodiments to receive program memory/firmware updates, and receive/transmit information such as for technical support.

It will also appreciate that the device 1400 of FIG. 14 (as well as other devices described herein) might utilize so-called “virtualized” processing cores or resources. For instance, a virtual processor or memory component might be comprised of portions of resources of two or more discrete physical devices, which are logically aggregated to provide the appearance and functionality of a unitary physical device.

The illustrated device 1400 also includes in program memory code 1407 which manages the utilization of the now-encapsulated multiple global data variables. This includes, among other things, insertion of the instantiated name “RTOS_Globals” to be supplied in front of any global data access. For example, the processing can prepend “RTOS_Globals”, changing the access to “RTOS_Globals.RTOS_Current_Thread.” Mutex, queue, and other operations which need to access global data can be treated similarly; i.e., all accessing one data repository, in contrast to multiple discrete repositories as in the existing art.

In one variant, the encapsulating of the global data into a single C typedef, and then instantiating the single C typedef into a singular C global variable, enables the device 1400 to perform multi-threaded program execution based on a single global variable location (e.g., the value associated with R1 as previously described).

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. This description is in no way meant to be limiting, but rather should be taken as illustrative of the general principles of the disclosure. The scope of the disclosure should be determined with reference to the claims.

It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

What is claimed is:

1. A method for providing encapsulation of data variables used by an operating system, the computerized method comprising:
encapsulating a plurality of program global data into a single type of data; and
instantiating the single type of data as a single global variable for use by an RTOS (real time operating system) of a computerized device.

2. The method of claim 1, wherein the encapsulating of the plurality of program global data into the single type of data comprises encapsulating all global variables of C-based source code program into a single C typedef.

3. The method of claim 2, wherein:
the encapsulating of all the data of the global variables into the single typedef comprises encapsulating into a single global typedef accessible by all global RTOS operations.

4. The method of claim 3, further comprising prepending data identifying the single global typedef to at least one global data access data structure.

5. The method of claim 4, wherein the prepending comprises referencing a global pointer “RTOS_Current_Thread,” thereby changing an access of a global “RTOS_Globals” to “RTOS_Globals.RTOS_Current_Thread.”

6. The method of claim 1, wherein the encapsulating and the instantiating cooperate to cause use of respective memory locations having a prescribed relationship to one another, the prescribed relationship enabling performance of one or more functions which cannot be performed without the prescribed relationship.

7. The method of claim 6, wherein:
the prescribed relationship comprises the respective memory locations being disposed in a prescribed order or pattern; and
the one or more functions comprise at least one of an error detection or error correction function.

8. The method of claim 1, wherein the encapsulating of the plurality of program global data into the single type of data comprises determining to encapsulate only a portion of a plurality of global variables of C-based source code program into a single C typedef, the determining based on one or more factors, the one or more factors comprising at least one of processing or memory limitations.

9. The method of claim 1, wherein the encapsulating of the plurality of program global data into the single type of data comprises utilizing one or more machine learning algorithms to analyze data to determine to encapsulate the plurality of program global data.

10. The method of claim 1, further comprising:
verifying the plurality of program global data; and
based on the verifying of the plurality of program global data indicating the plurality of program global data is valid, causing at least one of (i) applying verification data to the single type of data, or (ii) updating existing verification data within the single type of data.

11. The method of claim 10, wherein the verifying of the plurality of program global data comprises:
specifying plurality of program global data in respective storage locations according to at least one of a prescribed order or prescribed pattern; and
utilizing knowledge of the at least one of the prescribed order or the prescribed pattern so as to facilitate performance of one or more other operations.

12. The method of claim 10, wherein the causing of the at least one of (i) the applying of the verification data to the single type of data, or (ii) the updating of the existing verification data within the single type of data comprises disposing one or more verification codes at a beginning of the plurality of program global data or at an end of the plurality of program global data, the one or more verification codes facilitating the detection of at least one of stack overflow or buffer overflow.

13. Computerized embedded apparatus, comprising:
data storage apparatus;
processor apparatus in data communication with the storage apparatus; and
storage apparatus in data communication with the processor apparatus, the storage apparatus comprising at least one computer program having a plurality of instructions, the plurality of instructions configured to, when executed by the processor apparatus, cause the computerized apparatus to:
execute an RTOS program;
determine that access to particular global data is required by the RTOS program to perform a function of the RTOS;
utilize data indicative of a single reference to aggregated global data to access the particular global data; and
access the particular global data via the single reference to enable performance of the function.

14. The computerized embedded apparatus of claim 13, wherein the single reference to the aggregated global data comprises a single reference to an encapsulation of the particular global data, the encapsulation utilizing less instruction memory area and instructions to execute than a code generation process that does not utilize the encapsulation.

15. The computerized embedded apparatus of claim 13, wherein the aggregated global data comprises at least two sets of global data having a prescribed relationship.

16. The computerized embedded apparatus of claim 13, wherein the plurality of instructions are further configured to, when executed by the processor apparatus, cause the computerized apparatus to:
display the aggregated global data via a graphical user interface (GUI), wherein utilization of the data indicative of the single reference to the aggregated global data to access the particular global data enables the display to be effected with less individual accesses to different locations in memory than without the utilization of the data indicative of the single reference to the aggregated global data to access the particular global data, the display facilitating at least one of (i) troubleshooting, (ii) error correction, or (ii) debug, by a programmer or support entity.

17. Computer readable apparatus comprising a non-transitory storage medium, the non-transitory storage medium comprising at least one computer program having a plurality of instructions, the plurality of instructions configured to, when executed by a processing apparatus, cause a computerized apparatus to:
encapsulate global data used by a real-time operating system (RTOS) program into a single C typedef; and
instantiate the single C typedef as a singular C global variable for subsequent use by the RTOS on an embedded target platform.

18. The computer readable apparatus of claim 17, wherein the plurality of instructions are further configured to, when executed by the processing apparatus, cause the computerized apparatus to:
determine to encapsulate the global data into the single C typedef based on one or more thresholds being met, the one or more thresholds comprising a number of bytes of the global data.

19. The computer readable apparatus of claim 17, wherein the plurality of instructions are further configured to, when executed by the processing apparatus, cause the computerized apparatus to:
apply a pragma extension to the instantiation of the single C typedef as the singular C global variable, the application of the pragma extension ensuring a minimal address alignment of bytes and an absolute address.

20. The computer readable apparatus of claim 19, wherein the plurality of instructions are further configured to, when executed by the processing apparatus, cause the computerized apparatus to:
utilize the minimal address alignment of bytes and an absolute address to lock the global data into at least one cache memory location associated with the computerized apparatus.
